(19) United States
(12) Patent Application Publication
(10) Pub. No.: US 2026/0193908 A1
(43) Pub. Date: Jul. 9, 2026

(54) VEHICLE ELECTRONIC LATCH TRANSITIONING SYSTEM AND TRANSITIONING METHOD

(71) Applicant: Ford Global Technologies, LLC, Dearborn, MI (US)

(72) Inventors: Marco Sanchez, Atizapan de Zaragoza (MX); Cesar Navarro, Naucalpan (MX); Iván Nava Cardeño, Metepec (MX); David Franco Lopez Rubio, Aguascalientes (MX)

(21) Appl. No.: 19/009,007

(22) Filed: Jan. 3, 2025

(51) Int. Cl. E05B 81/82; B60R 25/24; B60R 25/40; E05B 83/24

(52) U.S. Cl. CPC E05B 81/82; B60R 25/24; B60R 25/40; E05B 83/24; B60R 2325/205

(57) ABSTRACT

A vehicle assembly includes an electronic latch that transitions between a latched state and an unlatched state. The electronic latch is configured to hold a closure assembly of a vehicle in a closed position when the electronic latch is in the latched state. The electronic latch is configured to permit movement of the closure assembly from the closed position to an open position when the electronic latch is in the unlatched state. A wireless energy transfer access point is configured to wirelessly receive energy that powers a transition of the electronic latch from the latched state to the unlatched state. The energy is provided by an energy providing device that is separate from the vehicle.

### TECHNICAL FIELD

This disclosure relates generally to transitioning an electronic latch of a vehicle without relying on a battery of the vehicle to power the electronic latch.

### BACKGROUND

Vehicles can include closure assemblies such as side doors, trunk lids, and frunk lids. An electronic latch can be used to hold a closure assembly of a vehicle in a closed position. A battery, such as a 12-Volt accessory battery, of the vehicle typically powers the electronic latch.

### SUMMARY

In some aspects, the techniques described herein relate to a vehicle assembly, including: an electronic latch that transitions between a latched state and an unlatched state, the electronic latch configured to hold a closure assembly of a vehicle in a closed position when the electronic latch is in the latched state, the electronic latch configured to permit movement of the closure assembly from the closed position to an open position when the electronic latch is in the unlatched state; and a wireless energy transfer access point configured to wirelessly receive energy that powers a transition of the electronic latch from the latched state to the unlatched state, the energy provided by an energy providing device separate from the vehicle.

In some aspects, the techniques described herein relate to a vehicle assembly, further including a battery of a vehicle that powers a transition of the electronic latch from the latched state to the unlatched state when a state of charge of the battery is above a threshold value, the energy received through the wireless energy transfer access point powering the transition of the electronic latch when the state of charge of the battery is below the threshold value.

In some aspects, the techniques described herein relate to a vehicle assembly, wherein the battery is an accessory battery of the vehicle.

In some aspects, the techniques described herein relate to a vehicle assembly, wherein the battery is a 12-Volt battery.

In some aspects, the techniques described herein relate to a vehicle assembly, wherein the battery is inaccessible when the closure assembly is in the closed position, and accessible when the closure assembly is in the unlatched state.

In some aspects, the techniques described herein relate to a vehicle assembly, wherein the battery is an accessory battery held within a frunk that is covered by the closure assembly when the closure assembly is in a closed position, the accessory battery operatively coupled to the electronic latch.

In some aspects, the techniques described herein relate to a vehicle assembly, wherein the closure assembly is a frunk lid.

In some aspects, the techniques described herein relate to a vehicle assembly, further including a wireless charging coil of the wireless energy transfer access point.

In some aspects, the techniques described herein relate to a vehicle assembly, wherein the wireless energy transfer access point is disposed in a front facia.

In some aspects, the techniques described herein relate to a vehicle assembly, wherein the wireless energy transfer access point includes a logo.

In some aspects, the techniques described herein relate to a vehicle assembly, wherein the energy providing device is a smartphone of a user. wherein the wireless energy transfer access point is configured to receive energy wirelessly from a smartphone of a user.

In some aspects, the techniques described herein relate to a vehicle assembly, wherein the wireless energy transfer access point is configured to receive energy wirelessly from a smartphone of an authorized user.

In some aspects, the techniques described herein relate to a vehicle assembly, wherein the vehicle is configured such that energy received from the energy providing device through the wireless energy transfer access point is conveyed directly to the electronic latch without the energy being stored in a battery.

In some aspects, the techniques described herein relate to a vehicle latch electronic transitioning method, including: receiving energy though a wireless energy transfer access point of a vehicle; and with the energy, powering a transition of an electronic latch of the vehicle from a latched state to an unlatched state.

In some aspects, the techniques described herein relate to a vehicle latch electronic transitioning method, further including permitting the powering when the vehicle is in a wireless transfer receiving mode, and blocking the powering when the vehicle is not in the wireless transfer receiving mode.

In some aspects, the techniques described herein relate to a vehicle latch electronic transitioning method, further including transitioning to the wireless transfer receiving mode in response to a state of charge of an accessory battery falling below a threshold value.

In some aspects, the techniques described herein relate to a vehicle latch electronic transitioning method, wherein the accessory battery is accessible when a closure assembly of the vehicle is in an open position, wherein the closure assembly is moveable to the open position when the latch is in the unlatched state.

In some aspects, the techniques described herein relate to a vehicle latch electronic transitioning method, further powering the electronic latch with an accessory battery of the vehicle when the state of charge is at or above the threshold value.

In some aspects, the techniques described herein relate to a vehicle latch electronic transitioning method, wherein the energy directly powers the electronic latch without storing the energy in a battery.

In some aspects, the techniques described herein relate to a vehicle latch electronic transitioning method, wherein the energy is received from a smartphone.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having an electronic latch and a closure assembly according to an exemplary aspect of the present disclosure.

FIG. 2 shows a close-up perspective view of a front corner area of the electrified vehicle of FIG. 1 showing a wireless energy transfer access point, the closure assembly, and a frunk of the vehicle.

FIG. 3 illustrates a schematic view of the vehicle of FIGS. 1 and 2 having an electronic latch powered by an energy providing device separate from the vehicle.

### DETAILED DESCRIPTION

This disclosure relates generally to powering an electronic latch using energy that is transferred wirelessly to a vehicle. The energy can be wirelessly transferred to the vehicle from a user’s smartphone, for example.

During operation of the vehicle, the latch can be powered by an accessory battery of the vehicle. If the accessory battery state of charge is insufficient to power the latch, the latch can be powered by the energy that is wirelessly transferred to the vehicle. In some examples, the latch can be powered by the energy wirelessly transferred to the vehicle only when the accessory battery state of charge is insufficient to power the latch.

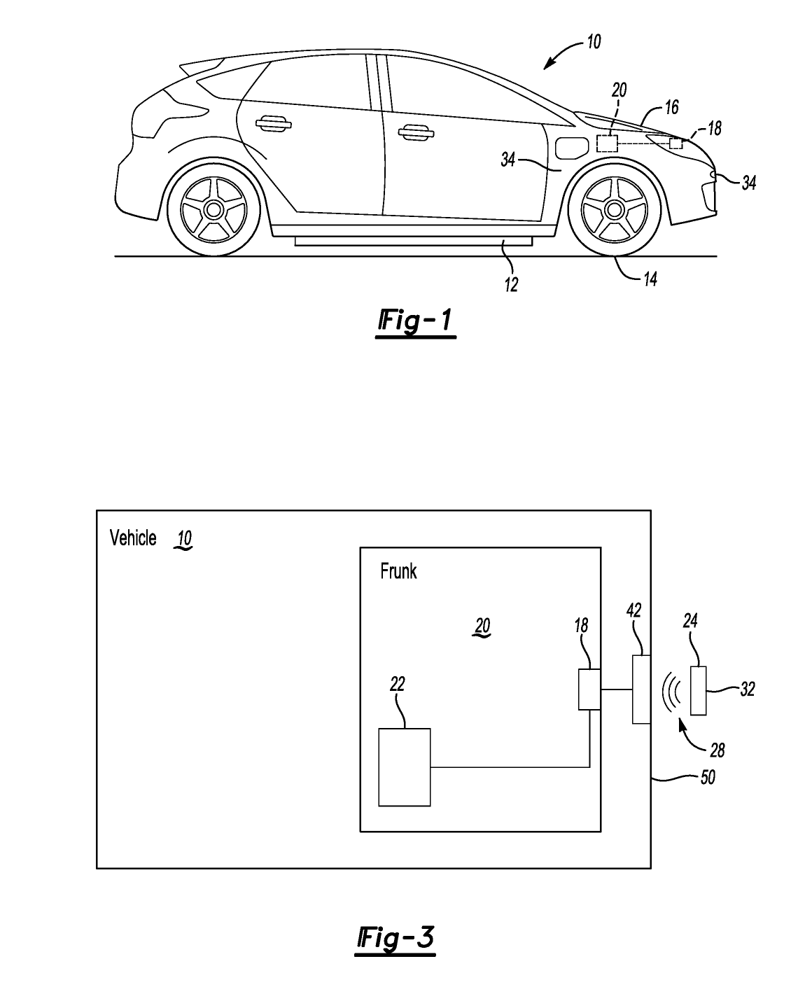

With reference to FIGS. 1–3, an exemplary electrified vehicle 10 is a battery electric vehicle (BEV) that includes a traction battery 12. The vehicle 10 can have a powertrain incorporating a drive system that rotates drive wheels 14 utilizing torque from an electric machine that is powered by the traction battery 12.

The exemplary electrified vehicle 10 is an all-electric vehicle, however, other types of vehicles fall within the scope of this disclosure, including conventional vehicles that rely on an internal combustion engine to provide drive power, and hybrid vehicles that can rely on an electric machine, an internal combustion engine, or both.

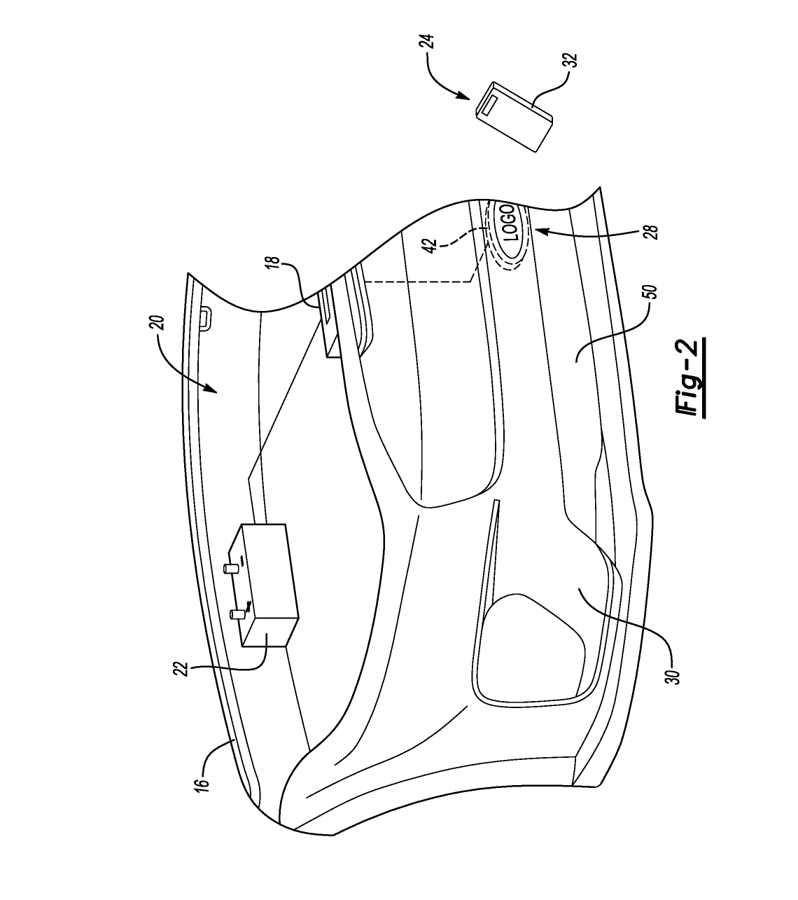

The vehicle 10 includes a closure assembly 16 and an electronic latch 18. The closure assembly 16 can pivot back and forth between a closed position and an open position. The electronic latch 18 can be transitioned to a latched state to hold the closure assembly 16 in a closed position as shown in FIG. 1. The electronic latch 18 can be transitioned to an unlatched state to permit movement of the closure assembly 16 from the closed position to an open position shown in FIG. 2. During ordinary operation of the vehicle 10, the electronic latch 18 can be transitioned in response to a user pressing a button on a keyfob or within a passenger compartment of the vehicle 10. The vehicle 10 can be a vehicle 10 that does not include conventional key cylinders.

Powering the electronic latch 18 can transition the electronic latch 18 from the latched state to the unlatched state. The electronic latch 18 can be an “E-latch” that unlatches when an electric actuator of the electronic latch 18 is powered. The electronic latch 18 is a 10-Volt electronic latch in this example.

The closure assembly 16 is a frunk lid in this example. In the closed position, the closure assembly 16 covers a frunk 20, which is in a forward area of the vehicle 10. In a conventional vehicle, the forward area is typically used to house an engine. Since the vehicle 10 is an all-electric vehicle, the front area is available for use as the frunk 20. When the closure assembly 16 is pivoted to an open position, the frunk 20 is accessible. When the electronic latch 18 is in a latched state, the electronic latch 18 can hold the closure assembly 16 in the closed position thereby blocking access to the frunk 20.

The exemplary electrified vehicle 10 uses the frunk 20 to, among other things, hold an accessory battery 22, which is a 12-Volt battery in this example. The accessory battery 22 is a relatively low voltage battery when compared to the traction battery 12. The accessory battery 22 can be used to power various loads on the vehicle 10. In this example, the accessory battery 22 is operably coupled to the electronic latch 18 such that the electronic latch 18 can be powered by the accessory battery 22. In this example, the accessory battery 22 is inaccessible to a user when the closure assembly 16 is in the closed position. Recharging the accessory battery 22 thus requires opening the closure assembly 16.

From time to time, a state of charge of the accessory battery 22 may decrease such that the accessory battery 22 is not able to adequately power the electronic latch 18 to unlatch. As can be appreciated, the accessory battery 22 may not be accessible to recharge if the closure assembly 16 is held in the closed position by the electronic latch 18.

In the exemplary embodiment, the electronic latch 18 can be powered with energy from a source other than the accessory battery 22. This ensures that the electronic latch 18 can transition to the unlatched state so that the closure assembly 16 can then be opened and the accessory battery 22 accessed.

The example vehicle 10 is configured to receive energy that can be used to power a transition of the electronic latch 18 from an energy providing device 24 that is separate from the vehicle 10. The vehicle 10 can receive the energy wirelessly through a wireless energy transfer access point 28 of the vehicle 10. The energy providing device 24 can be a smartphone 32 of the user. The energy providing device 24 could be a keyfob in another example.

When the wireless energy transfer access point 28 is active, the user can hold the smartphone 32 near the wireless energy transfer access point 28 so that energy can transfer from the smartphone 32 through the wireless energy transfer access point 28 to the electronic latch 18. The energy transfer can be considered an inductive energy transfer.

The wireless energy transfer access point 28 includes a receiver coil 42 disposed behind a trim component 50 — here a front facia — of the vehicle 10. To transmit energy to the electronic latch 18, the user can hold the smartphone 32 against the trim component 50 adjacent to the receiver coil 42. The smartphone 32 is a smartphone equipped for to transfer wireless charge. The smartphone 32 can include a transfer coil that is compatible with the receiver coil 42.

Energy from the smartphone 32 is received by the receiver coil 42 and routed to the electronic latch 18 to power the unlatching. In this example, the energy is routed from the wireless energy transfer access point 28 to the electronic latch 18 without storing the energy in any battery. The vehicle 10, in some examples, includes a transformer that converts a voltage of the energy received so that the energy can power the electronic latch 18.

The user may initiate the energy transfer from an app on the smartphone 32. The app may be used to authenticate the user. That is, the energy transfer would only occur if the smartphone 32 is associated with an authorized user. The wireless energy transfer access point 28 could also include a unique identifier that securely authenticates with the smartphone 32. The app can provide instructions for how to initiate the wireless transfer of energy and can provide real-time feedback on the energy transfer process.

The authentication step can be used to block unauthorized users from unlatching the electronic latch 18 and opening the closure assembly 16. The user could be authorized in other ways in other examples. For example, the authorization may include verifying that the user attempting to transmit energy wirelessly through the wireless energy transfer access point 28 possesses a certain keyfob. Other methods of authenticating a user attempting to utilize the wireless energy transfer access point 28 could include requiring PIN identification or fingerprint recognition.

Instead or in additional to authenticating the user attempting to transmit energy wireless through the wireless energy transfer access point 28, the vehicle 10 may only activate the wireless energy transfer access point 28 at certain times. This can help to block unauthorized users from unlatching the electronic latch 18 and opening the closure assembly 16. A controller of the vehicle 10 can control activation of the wireless energy transfer access point 28. The receiver coil 42 is not able to receive energy unless activate by the controller.

In some examples, the wireless energy transfer access point 28 could be configured to activate only when a state of charge of the accessory battery 22 is below a threshold value. When the state of charge is below the threshold value, the state of charge of the accessory battery 22 is insufficient to power the transition of the electronic latch 18 to the unlatched state. That is, the threshold value can be a minimum state of charge sufficient for the accessory battery 22 to power the transition of the electronic latch 18 to the unlatched state. The threshold value for the state of charge could be, for example, fifty percent. In such an example, the wireless energy transfer access point 28 would only be usable when the accessory battery 22 has a state of charge insufficient to power the transition of the electronic latch 18.

In such an example, the vehicle 10 can have a wireless transfer receiving mode where the energy can be received wirelessly through the wireless energy transfer access point 28. The controller can activate the wireless transfer receiving mode when the state of charge falls below the threshold state of charge. During ordinary operation, when the accessory battery 22 is at or above the threshold state of charge, the vehicle 10 is not in a wireless transfer receiving mode.

In some examples, as here, the wireless energy transfer access point 28 can include a logo of the vehicle 10. The logo can indicate to the user where to hold the energy providing device. In this example, the wireless energy transfer access point 28 is located in a front facia of the vehicle 10. In other examples, the wireless energy transfer access point 28 could be in a grille of the vehicle 10, under a front fender of the vehicle 10, or within a charge port or charge port door of the vehicle 10.

In the past, unlatching an electronic latch when an accessory battery is unable to power the electronic latch has involved a user accessing terminals hidden behind a panel within a facia of a vehicle. The user physically connects a power source to the terminals to power the electronic latch. The present disclosure, in exemplary embodiments, powers the electronic latch without requiring panels to be removed or physical connections to be made. Energy is conveyed directly to the electronic latch from an external source without storing the energy in a battery.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A vehicle assembly, comprising:
an electronic latch that transitions between a latched state and an unlatched state, the electronic latch configured to hold a closure assembly of a vehicle in a closed position when the electronic latch is in the latched state, the electronic latch configured to permit movement of the closure assembly from the closed position to an open position when the electronic latch is in the unlatched state; and
a wireless energy transfer access point configured to wirelessly receive energy that powers a transition of the electronic latch from the latched state to the unlatched state, the energy provided by an energy providing device separate from the vehicle.

2. The vehicle assembly of claim 1, further comprising a battery of a vehicle that powers a transition of the electronic latch from the latched state to the unlatched state when a state of charge of the battery is above a threshold value, the energy received through the wireless energy transfer access point powering the transition of the electronic latch when the state of charge of the battery is below the threshold value.

3. The vehicle assembly of claim 2, wherein the battery is an accessory battery of the vehicle.

4. The vehicle assembly of claim 2, wherein the battery is a 12-Volt battery.

5. The vehicle assembly of claim 2, wherein the battery is inaccessible when the closure assembly is in the closed position, and accessible when the closure assembly is in the unlatched state.

6. The vehicle assembly of claim 2, wherein the battery is an accessory battery held within a frunk that is covered by the closure assembly when the closure assembly is in a closed position, the accessory battery operatively coupled to the electronic latch.

7. The vehicle assembly of claim 1, wherein the closure assembly is a frunk lid.

8. The vehicle assembly of claim 1, further comprising a wireless charging coil of the wireless energy transfer access point.

9. The vehicle assembly of claim 1, wherein the wireless energy transfer access point is disposed in a front facia.

10. The vehicle assembly of claim 1, wherein the wireless energy transfer access point comprises a logo.

11. The vehicle assembly of claim 1, wherein the energy providing device is a smartphone of a user. wherein the wireless energy transfer access point is configured to receive energy wirelessly from a smartphone of a user.

12. The vehicle assembly of claim 1, wherein the wireless energy transfer access point is configured to receive energy wirelessly from a smartphone of an authorized user.

13. The vehicle assembly of claim 1, wherein the vehicle is configured such that energy received from the energy providing device through the wireless energy transfer access point is conveyed directly to the electronic latch without the energy being stored in a battery.

14. A vehicle latch electronic transitioning method, comprising:
receiving energy though a wireless energy transfer access point of a vehicle; and
with the energy, powering a transition of an electronic latch of the vehicle from a latched state to an unlatched state.

15. The vehicle latch electronic transitioning method of claim 14, further comprising permitting the powering when the vehicle is in a wireless transfer receiving mode, and blocking the powering when the vehicle is not in the wireless transfer receiving mode.

16. The vehicle latch electronic transitioning method of claim 15, further comprising transitioning to the wireless transfer receiving mode in response to a state of charge of an accessory battery falling below a threshold value.

17. The vehicle latch electronic transitioning method of claim 16, wherein the accessory battery is accessible when a closure assembly of the vehicle is in an open position, wherein the closure assembly is moveable to the open position when the latch is in the unlatched state.

18. The vehicle latch electronic transitioning method of claim 16, further powering the electronic latch with an accessory battery of the vehicle when the state of charge is at or above the threshold value.

19. The vehicle latch electronic transitioning method of claim 14, wherein the energy directly powers the electronic latch without storing the energy in a battery.

20. The vehicle latch electronic transitioning method of claim 14, wherein the energy is received from a smartphone.
